(19) United States
(12) Patent Application Publication
(10) Pub. No.: US 2009/0171690 A1
(43) Pub. Date: Jul. 2, 2009

(54) SYSTEM AND METHOD FOR A WEB-BASED PEOPLE DIRECTORY

(75) Inventors: DAN LUBARSKI, WATERTOWN, MA (US); SERGEY PORFIRIEV, NEWTON, MA (US); SERGEY PRAZDNICHKOV, MOSCOW (RU)

Correspondence Address: AKC PATENTS, 215 GROVE ST., NEWTON, MA, 02466, US

(73) Assignee: HUMANBOOK, INC., WELLESLEY HILLS, MA (US)

(21) Appl. No.: 12/342,783

(22) Filed: Dec. 23, 2008

Related U.S. Application Data
(60) Provisional application No. 61/017,408, filed on Dec. 28, 2007.
(60) Provisional application No. 61/017,452, filed on Dec. 28, 2007.
(60) Provisional application No. 61/017,465, filed on Dec. 28, 2007.
(60) Provisional application No. 61/022,633, filed on Jan. 22, 2008.

(51) Int. Cl. G06Q 99/00; G06F 17/30; H04L 9/32; G06F 7/06; G06F 3/048

(52) U.S. Cl. 705/1; 707/102; 707/10; 726/4; 707/3; 715/742; 707/E17.108; 707/E17.111; 707/E17.044; 707/E17.018

(57) ABSTRACT

An online system and a method for a web-based people directory provides for collaborative updating of the directory information. The method includes creating profile templates for each person on earth and storing these profile templates in a central database (202). Next, populating the profile templates with publicly available basic information (204) and publishing the public profile information in the web-based directory (206). Users login into the directory website and update their own or other person's profile information (208). The updated information is added to the person's published profile (210).

### CROSS REFERENCE TO RELATED CO-PENDING APPLICATIONS

This application claims the benefit of U.S. provisional application Ser. No. 61/017,408 filed on Dec. 28, 2007 and entitled SYSTEM AND METHOD FOR A WEB-BASED PEOPLE DIRECTORY which is commonly assigned and the contents of which are expressly incorporated herein by reference.

This application is also related to and claims the benefit of co-pending U.S. provisional application Ser. No. 61/017,452 filed on Dec. 28, 2007 and entitled SYSTEM AND METHOD FOR A WEB-BASED ADDRESS BOOK which is commonly assigned and the contents of which are expressly incorporated herein by reference.

This application is also related to and claims the benefit of co-pending U.S. provisional application Ser. No. 61/017,465 filed on Dec. 28, 2007 and entitled SYSTEM AND METHOD FOR A WEB-BASED NETWORKING DATABASE which is commonly assigned and the contents of which are expressly incorporated herein by reference.

This application is also related to and claims the benefit of U.S. provisional application Ser. No. 61/022,633 filed on Jan. 22, 2008 and entitled SYSTEM AND METHOD FOR A WEB-BASED PEOPLE PICTURE DIRECTORY which is commonly assigned and the contents of which are expressly incorporated herein by reference.

### FIELD OF THE INVENTION

The present invention relates to a system and a method for a web-based people directory, and in particular to an online people directory that allows collaborative updating of the directory information.

### BACKGROUND OF THE INVENTION

Communications among people are fundamental for the formation and existence of a community and for conducting personal and business transactions. Written communications are usually delivered via mail or electronic mail (e-mail). Oral communications are usually delivered via telephone or in-person. For the delivery of a communication the contact information of the person receiving the communication needs to be known. Examples of contact information include postal address, business or residence address, phone number, e-mail address and the location coordinates of the receiver. Contact information of persons or entities is usually listed in directories such as phone directory, e-mail directory or an address directory. A printed directory is usually location specific and is published by the company providing the communication service, i.e., the phone company. Searching for a person's contact information usually involves looking up a person's name in a local directory.

The emergence of the virtual community of the World Wide Web (www) has allowed people to communicate with other people online and to form online social network groups without any location boundaries. Searching for the contact information of a person or an entity online involves accessing an online searching service and entering the name of the person in predetermined fields 61, 62 of a webpage 60, as shown in FIG. 1. Examples of such online people searching services include intelius.com, peopleLookup.com, whitepages.com, anywho.com, switchboard.com, and people.yahoo.com, among others. The search results are usually displayed in a new webpage 70, and may include, the person's name 64, phone number 66, address 67, and/or e-mail information, as shown in FIG. 2. Directories update their information in certain time intervals, such as once a year or 6 months, and not in real-time. Therefore the retrieved contact information may be wrong, outdated and in general not reliable. Furthermore, there is no way for correcting the published directory information by anyone else, but the database administrator.

Finding contact information and communicating with a person within an online social network group is usually easier. Examples of social network groups include www.facebook.com, www.linkedin.com and online alumni network of people who attended a specific college or university. These social network groups allow a user to create a personal profile, store it in the social network's database and publish it to the group. The published information is usually not verified by a third party and may be fictitious. A group member accesses his profile by logging into the group's website via a user identification and password and enters and/or modifies his profile information content. Access to the user's profile by other network members is controlled by the user. These prior art systems rely upon each group member actively managing and updating his online profile content, which is cumbersome and does not usually happen. Furthermore, this type of contact information is only available to the members of a specific group and is not publicly available.

Accordingly, there is a need for an online people directory that is publicly available and provides reliable and updated contact information for all people and entities.

### SUMMARY OF THE INVENTION

The invention provides a system and a method for a web-based people directory that includes collaborative updating of the directory information.

In general, in one aspect, the invention features a computer implemented method for an online directory including the following. First, generating a profile template for each person within a group and storing them in a central database and then populating each person's profile template with publicly available information. Next, publishing each person's profile template through a web-based people directory application executing on a first computing device. The web-based people directory application is adapted to be accessed by a first person through a browser executing on a second computing device and the second computing device is adapted to connect to the first computing device via a network connection. Next, providing a first webpage adapted to be viewed by the first person via the browser for the first person to login into the web-based people directory application and to search a second person's profile template in the central database. Next, retrieving the second person's profile template and displaying it in a second webpage adapted to be viewed by the first person through the browser. Next, updating the second person's profile information by the first person and then adding the updated profile information to the second person's profile template. Finally, displaying the updated profile template of the second person in the second webpage.

Implementations of this aspect of the invention may include one or more of the following features. The method may further include searching, retrieving and updating the first person's own profile information by the first person. The profile template comprises one or more fields including last name, first name, address, age, date of birth, phone number, e-mail address, education background, work address, personal address book, personal contacts and photographs. The method may further include selecting one or more of the fields to be publicly displayed in the profile template. The method may further include verifying and updating the second person's profile information by other persons. The method may further include the second person logging into the web-based people directory application, searching, identifying and retrieving own profile template and verifying and updating own profile information. The first person may upload his personal address book, which includes the names and contact information of the first person's personal contacts. The method may further include cross-correlating the uploaded names and contact information of the first person's personal contacts with information in the personal contacts' profile templates stored in the central database and updating the personal contacts' profile templates. The method may further include updating the contact information of the first person's personal contacts in the first person's personal address book based on information in the personal contacts' profile templates. The method may further include inviting the first person's personal contacts to join the web-based people directory application, verify information in their personal profile templates and then upload their personal address books. The method may further include generating a profile template for an uploaded personal contact of the first person when none exist in the central database. The second computing device may be a computer, a mobile phone, a pager, a television remote control, a PDA or combinations thereof. The group may be a group of people residing in a certain geographic area, a group of people belonging to a certain organization, or a group of all people on earth. The publicly available information may be data from telephone directories, business directories, marketing data, financial data or other legally accessible data. Each person's profile information is verified by answering preset questions formulated based on group common knowledge. The method may further include grouping together persons with the same field parameters into subgroups. The method may further include providing communication tools for communications between the persons within the group or the subgroups.

In general, in another aspect, invention features a computer system comprising a first computing device, a storage device, profile templates for each person on earth stored in a central database stored in the storage device and a web-based people directory application stored in the storage device. The web-based people directory application includes a first webpage adapted to be viewed by a first person through a browser executing on a second computing device. The second computing device is adapted to connect to the first computing device via a network connection. The first webpage prompts the first person to login into the web-based people directory application and to search second person's profile template stored in the central database. The web-based people directory application also includes a second webpage displaying the second person's retrieved profile template and providing means for the first person to update the second person's profile information.

In general, in another aspect, invention features an interactive web-based people directory application stored in a first computing device and adapted to be accessed by a first person via a second computing device connecting to the first computing device via a network connection. The application includes a first webpage adapted to be viewed by the first person through a browser executing on the second computing device. The first webpage prompts the first person to login into the web-based people directory application and to search second person's profile template stored in a central database. The application also includes a second webpage adapted to be viewed by the first person through the browser. The second webpage displays the second person's profile template and provides means for the first person to update the second person's profile information.

In general, in another aspect, invention features a display device including a first graphical user interface and a second graphical user interface. The first graphical user interface comprises a first row and a control. The first row comprises a prompt to a first person to login into a web-based people directory application and to search second person's profile template stored in a central database. Actuation of the control initiates the searching and retrieval of second person's profile template. The second graphical user interface comprises one or more rows displaying the second person's retrieved profile template and additional controls. Activation of the additional controls allows the first person to update information in the second person's profile template.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 depicts a prior art online directory search service;

FIG. 2 illustrates search results obtained with the online directory search service of FIG. 1;

FIG. 3 is an overview diagram of the online directory system according to this invention;

FIG. 4 is a schematic diagram of the database of FIG. 3;

FIG. 5 depicts a profile template as stored in the database;

FIG. 6 depicts the publicly available directory profile based on the profile of FIG. 5;

FIG. 7 illustrates the process of creating the collaborative people directory of this invention;

FIG. 8 depicts the personal profile information of a user, as it is stored in the database;

FIG. 9 depicts the published directory information for the user of FIG. 8;

FIG. 10 is an overview diagram of a web-based address book system;

FIG. 11 is a schematic diagram of the common address book of FIG. 10;

FIG. 12 depicts a profile template as stored in the common address book of FIG. 10;

FIG. 13 illustrates the process of creating the collaborative web-based address book of this invention;

FIG. 14 depicts a schematic diagram of a social network;

FIG. 15 depicts a profile template as stored in the database of FIG. 10;

FIG. 16 illustrates the process of creating the collaborative social networking database of this invention; and

FIG. 17 depicts a schematic diagram of the matrix of shared connections.

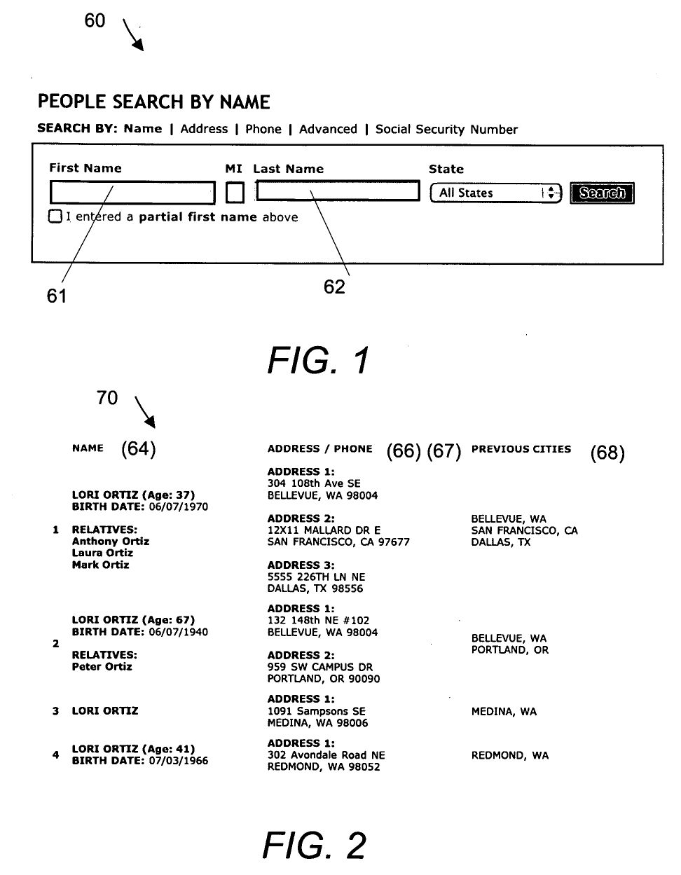

### DETAILED DESCRIPTION OF THE INVENTION

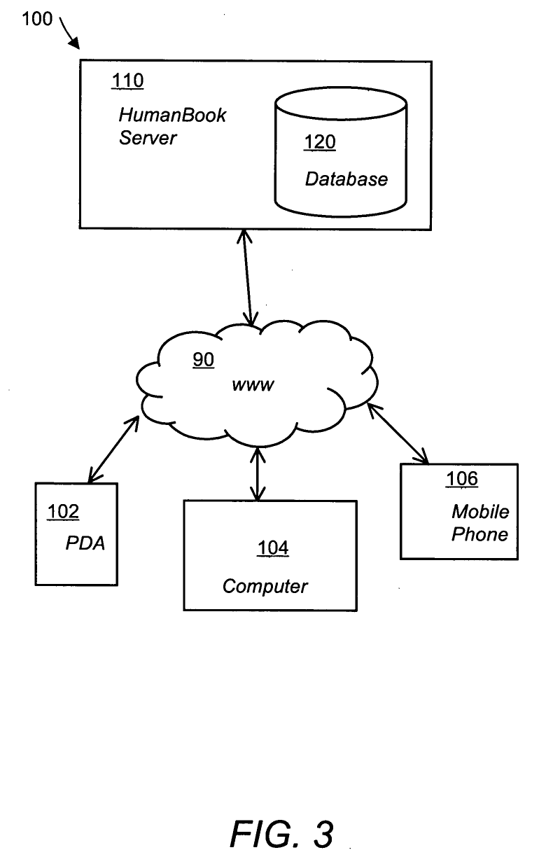

Referring to FIG. 3, a web-based people directory 100 includes a database 120, a server 110 and client communication devices 102, 104, 106. The client communication devices include a Personal Digital Assistant (PDA) 102, a computer 104, and a mobile phone 106. In other examples, the client communication devices may be wired or wirelesses devices including a pager, a wireless laptop computer, a personal computer, a television remote control, or combinations thereof. The client communication devices access the server 110 and database 120 via a network connection 90. In one example, network connection 90 is the Internet. In other examples, the network connection 90 may be a phone network, a cable network, or other wireless or a wired networks.

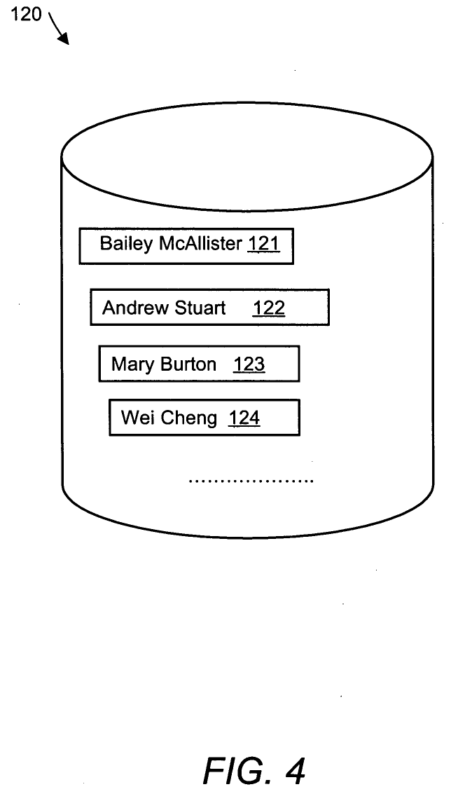

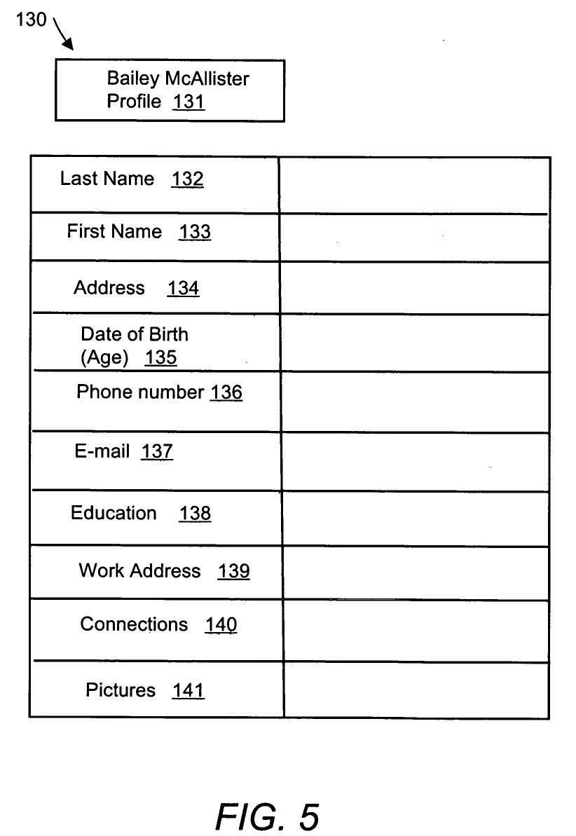

Database 120 includes personal data profiles of people. Examples of people whose profiles are listed in database 120 are people residing in a certain geographic area or people belonging to a certain organization or group, or in general all people on earth, as shown in FIG. 4. Database 120 also includes profiles of entities including businesses, educational institutions and organizations, among others. For every person or entity the system has a unique index preset and empty fields preserved for all attributes related to that person or entity. Referring to FIG. 5, the profile for Bailey McAllister 130 includes the unique preset index 131 and parameter fields for last name 132, first name 133, address 134, date of birth or age 135, phone number 136, education 138, work address 139, personal and/or business connections 140, pictures 141, among others. Basic information for each profile is preloaded by the system administrator based on publicly available data. The basic information is defined as information sufficient for identifying and matching a specific person with a specific profile. In one example, the basic information is a name and/or any of the other mentioned parameters. Publicly available data include data from phone directories, business directories, marketing data and financial data, among others. In other examples, other legally accessible data are also included. The basic profile information is published and then other people including the person to whom the profile belongs contribute, edit and modify the profile information. This unique feature of the system allows people to share knowledge about a person and record it to preset database fields of the person's profile. The profile index and the individual profile fields have unique locations, which can be searched and easily found. The system is self updated and the information is always current because people contribute to it and edit it. Since every piece of information has a unique location—once somebody changes it, all people can see the updated information because everyone is linked to the same index field of information. This web-based people directory system is a Web 2.0 website that combines the online social network attributes with the ability to contribute content and information while allowing users to exercise control over their data. Web 2.0 websites refer to web-based communities and hosted services, which facilitate creativity, collaboration and sharing between users. A more detailed discussion of Web 2.0 websites is presented in Wikipedia http://en.wikipedia.org/wiki/Wen_{—}2, the contents of which is incorporate herewith.

The web-based people directory system 100 functions as a common memory storage that allows people to record and preserve their memories—attributes of contact information, people connections, past events and biographical facts. Because other people can record information about a person, it allows people to memorialize facts about a person and recall something that would have been forgotten, since somebody may still remember it and record it in a proper information field.

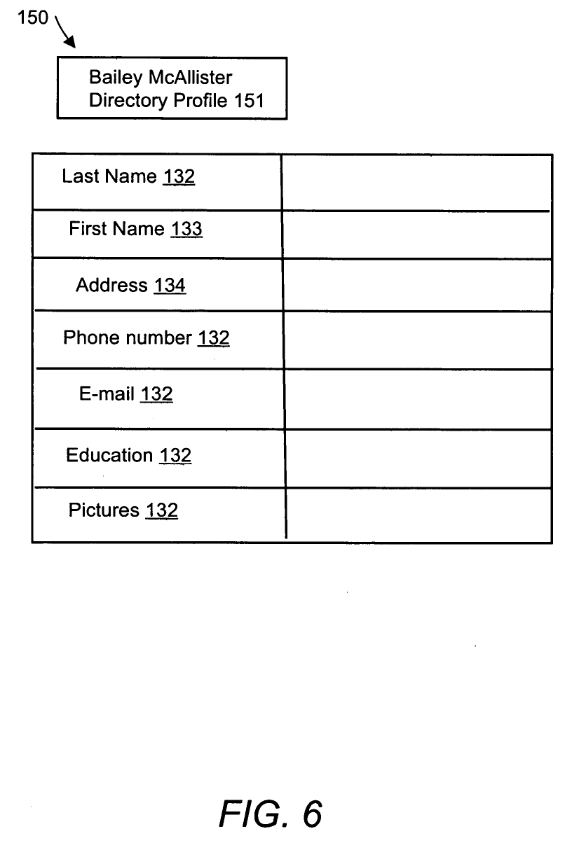

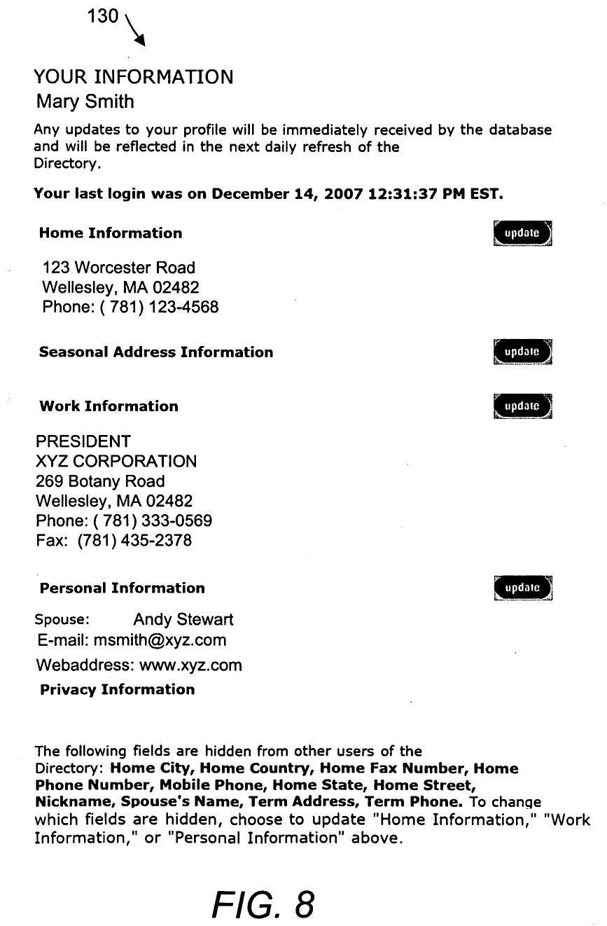

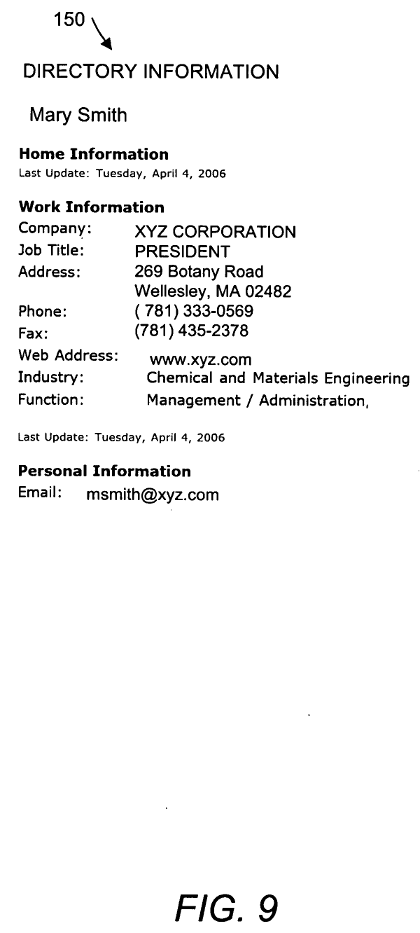

As was mentioned above, each person has control over their profile data and can turn on or off access and visibility of any particular parameter field. In the example of FIG. 6, Bailey McAllister has turned off the fields of Date of Birth 135, work address 139 and connections 140 and allowed publishing of the fields last name 132, first name 133, address 134, phone number 136, e-mail 137, education 138 and pictures 141 in the public directory profile. Referring to FIG. 8, the database profile information for Mary Smith includes her home address and phone number, her work address and phone numbers and personal information, such as spouse's name, e-mail address, and personal web-address. As shown in FIG. 9, all fields of home information, spouse's name and web-address are hidden from other users of the directory.

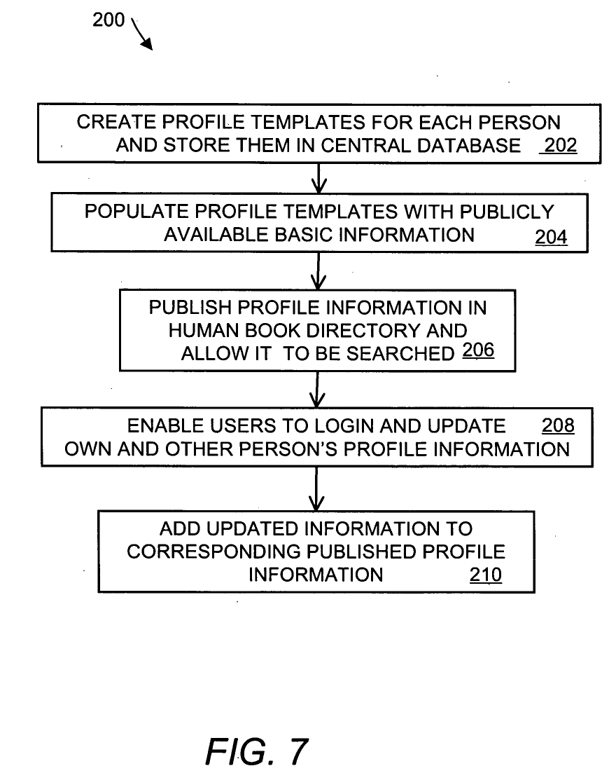

Referring to FIG. 7, the process 200 for generating the web-based directory 100 includes the following steps. First, creating profile templates for each person on earth and storing these profile templates in a central database (202). Next, populating the profile templates with publicly available basic information (204) and then publishing the public profile information in the web-based directory (206) and allowing it to be searched. Users are allowed to login into the directory website and update their own or other person's profile information (208). Finally the updated information is added to the person's published profile (210). All submissions are eponymous and can be traced back to the originator of the information. The system is governed by rules that do not allow publishing of negative information in a profile, i.e., all published information is positively bound. All profile information entries are verified either by other members of the community to which the specific person belongs or by answering preset questions formulated based on common knowledge. In one example, a person's attendance of a particular school is verified based on answering a question about a teacher who taught at the particular school during the time period of reference. In this example, the question may be either the name of the teacher or subject matter taught by the teacher, or a specific event that happened in the teacher's presence.

Furthermore, the system allows searching of the directory entries based on the various field parameters and main index and it provides accurate information easily and fast to those who need it and to those who are authorized to access it. Users with the same field parameters/attributes are matched and united in entities, groups or communities for communication purposes. The system also provides a platform and tools for communications and community group building.

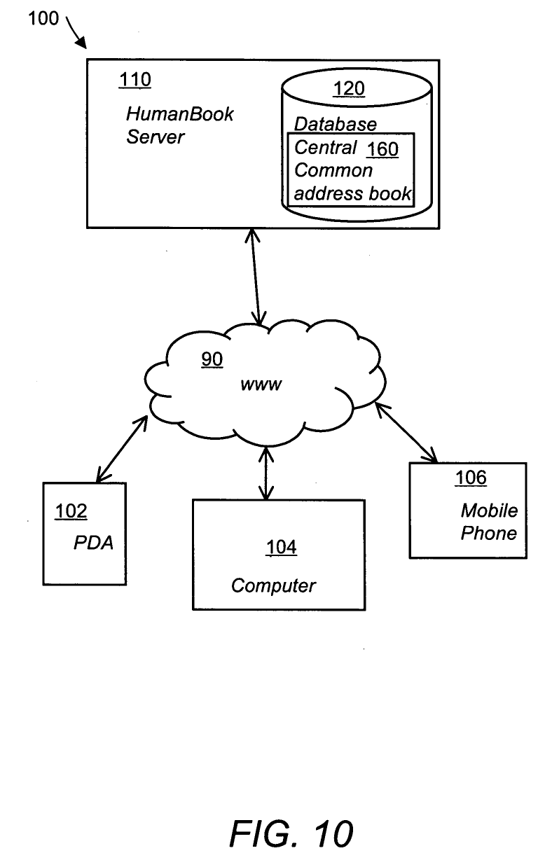

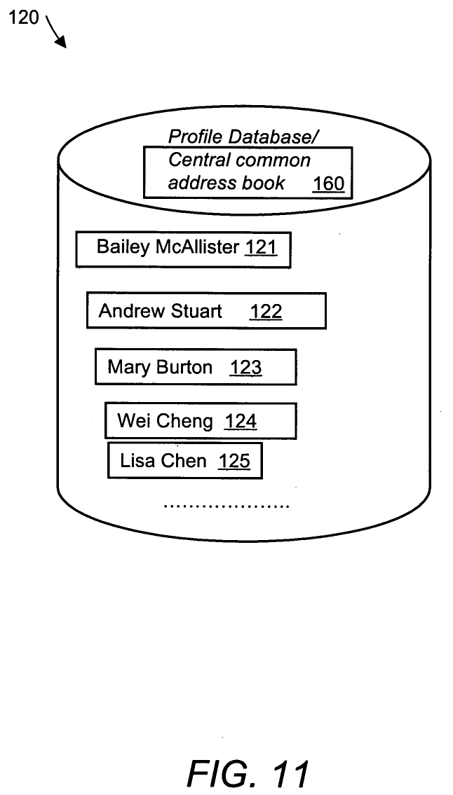

In one embodiment, database 120 is used to create a central common address book 160, shown in FIG. 10 and FIG. 11. The central common address book 160 is created by the system administrator and stored in the server 110. This central common address book is the integrator of every person's profile, list of contacts (address books) and the distributor of people's contacts to every person. The contact information is stored in the server and is updated by people in real time.

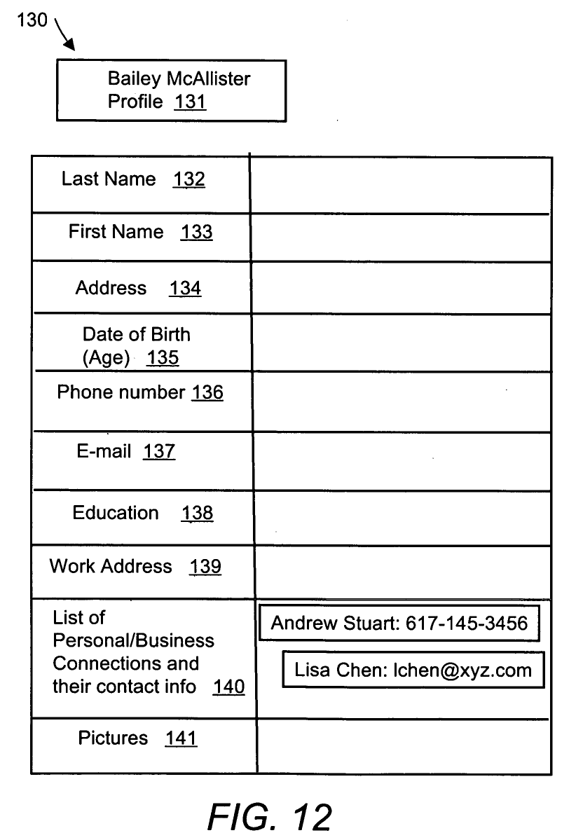

The contact information in the web-based address book system is organized and is matched and linked to real people's profiles. In the example of FIG. 12, Bailey McAllister is the owner of an address book 140 (i.e., list of personal contacts and their contact information) that includes the names of Andrew Stuart and Lisa Chen, as her personal contacts. For Andrew Stuart a phone number is listed and for Lisa Chen an e-mail address is listed. The system matches Andrew Stuart's phone number as listed in Bailey McAllister's address book 140 to his personal preexisting profile 122 in database 120, shown in FIG. 11, and enters it into his profile phone number field 136. Similarly Lisa Chen's e-mail address is matched to her preexisting profile 125 in database 120, shown in FIG. 11, and entered into her profile e-mail information field 137. People whose contact information is uploaded by others and have not joined the service or activated their personal profile, are invited to join the service, activate their profile and fill in their profile information. They are also invited to upload their personal contacts and contact information for their personal contacts. This matching and cross-correlation of contact information is performed by the system administrator or the users of the system. In other examples an automatic tool matches the uploaded contact information to people's profiles.

Thus people invite other people to join this web-based address book service using the provided contact information. It is a promotional chain wave. The more people use the system and the more profiles are active, the better and more reliable services this system offers. A matrix of contact information is being formed.

Contact information, uploaded by many, is shared and a common address book is created. The common address book is usually updated in real time, enriched with additional data and new contacts. If profiles of two or more people are linked together by common field information, then it is implied that these two or more people share the contact information of each other. Access to the contact information of each other is granted according to contact owners' preferences. Users can manage their contact information access preferences and who, out of the connected profiles, can get their current contact info. If a profile was not visited by its owner and access preferences were not set, then default settings are in place. If contact information is not shared and not available to other users, other users can leave a message for that person on the system.

If any contact information changes, i.e. gets updated by another person or if a profile owner changes his own contact information, this change automatically updates the profile owner's contact information on all other users' address books, which were linked to this profile. In this way a person's contact information is current and gets updated in real time.

People can also get the contact information of someone, whom they don't personally know, but want to contact, if the contact information is shared by somebody, who has contact access privileges. This system makes it easy to communicate and network with other people and make new connections.

Updated contact information is distributed to authorized people and is available anytime for download or for usage on site. Special tools allow synchronization and export of information from the updated central address book to address books stored in people's client devices, such as mobile phones, PDAs, personal computers and pagers, among others.

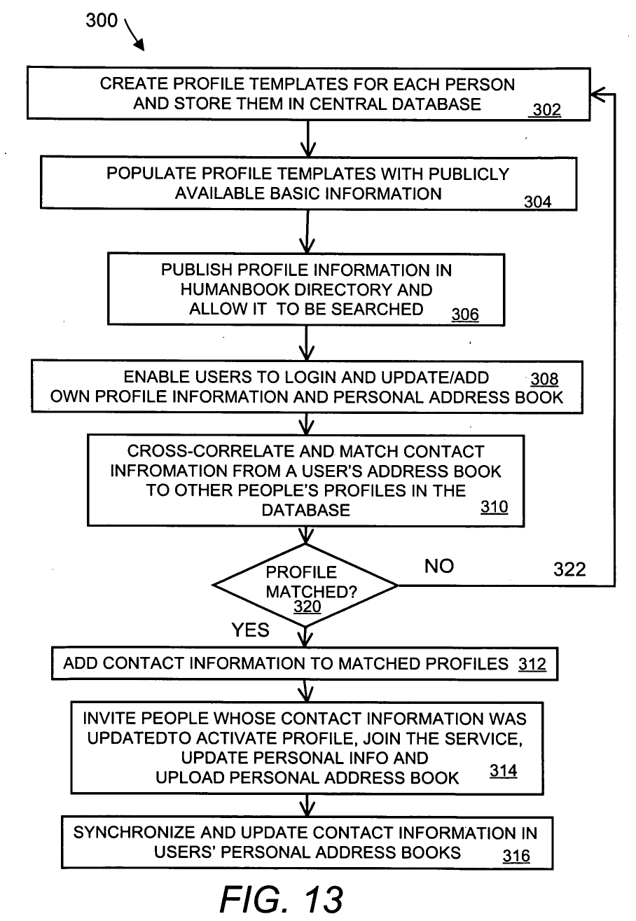

Referring to FIG. 13, the process 300 for generating the web-based common address/directory book 120 includes the following steps. First, creating profile templates for each person on earth and storing these profile templates in a central database (302). Next, populating the profile templates with publicly available basic information (304) and then publishing the public profile information in the web-based directory (306) and allowing it to be searched. Users are allowed to login into the directory website, update their own profile information and upload their personal address book (308). Next, the system cross-correlates and matches contact information retrieved from users' personal address books to other people's profiles in the database (310). This matching of the contact information to a person's profile is done automatically or manually by the user or the administrator. If a profile match is found (320) the contact information is added to the matched profile (312). The person whose contact information was added is invited to activate his profile, join the service, update personal profile information and upload personal address book (314). The invitation may be sent by the system administrator, the user from whose address book the contact information was retrieved or any other user. All submissions are eponymous and can be traced back to the originator of the information. Finally the system synchronizes and updates the entered /updated contact information is in all users' personal address books (314). If a profile match was not found in step 320 a new profile is created and added in the database (322).

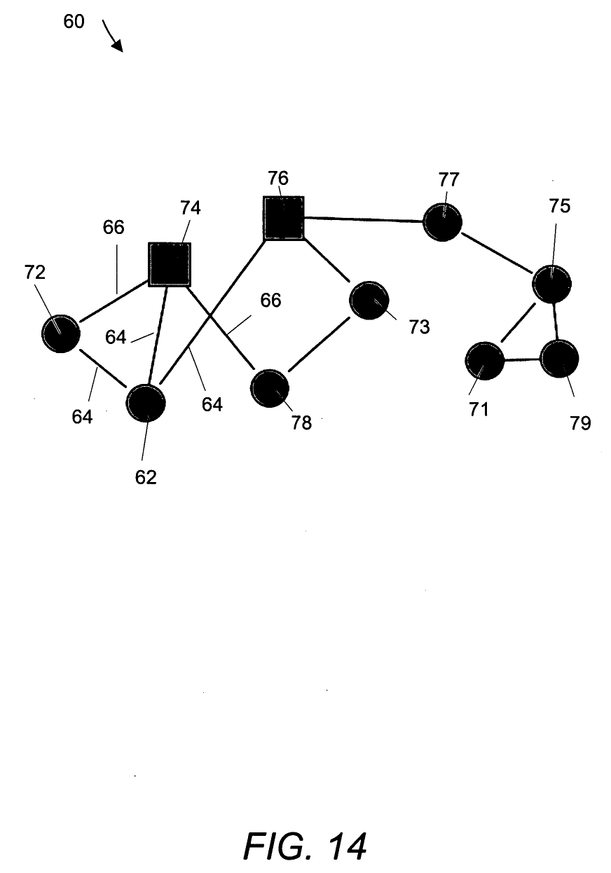

In another embodiment, database 120 is used to generate a web-based social network database. Social networks are social structures comprising individuals or organizations that are connected to each other by similar ethnic or cultural origin, educational history and background, profession, interests, hobbies, trade, political views, values, visions, ideas, conflicts, financial interests and activities, friends, problems, religion or any other personal or behavioral characteristic. Referring to FIG. 14, a schematic diagram of a social network 60 includes individuals 62, 72, 78, 73, 77, 71, 75, 79 or organizations 74, 76 connected to each other via connections or relationships 64, 66. The connections may be direct or indirect. In this example, individual 62 has direct connections 64 to individual 72 and organizations 74 and 76 and indirect connections to all other individuals 78, 77, 73, 75, 71 and 79.

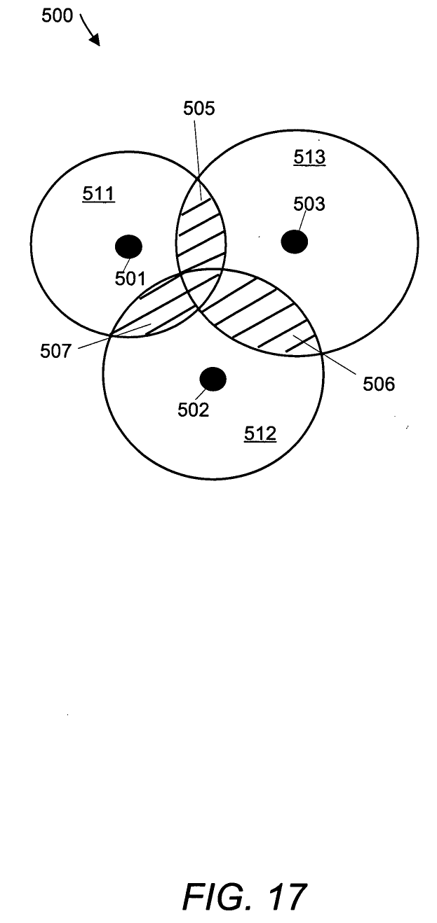

Referring to FIG. 17, individual persons 501, 502, 503 recall all their connections 511, 512, 513, respectively, that they had with other people and organizations and record this information to the system 100. As shown, person 501 shares connections 505 with person 503 and connections 507 with person 502. Also, person 502 shares connections 506 with person 503. Thus persons 501, 502, 503 form a common matrix of connections comprising shared connections 505, 506, 507. In other words, people link existing profiles of real people and/or organizations according to real life connections. All connections that happened, happening or will happen are recorded. Even if some connection is lost or forgotten, by using this system, it can be restored and recorded because there are at least 2 persons in each connection and often there are many witnesses of an existing connection. A person can record own connections and can record connections of other people if there is a direct knowledge and a direct relationship. For example, a person can identify that another person had also studied at a certain school. Additional information can be recorded by people for other people. However, certain information can be accessed by everyone and some information can be only accessed by a few chosen people. Privacy settings are specified by the profile owner.

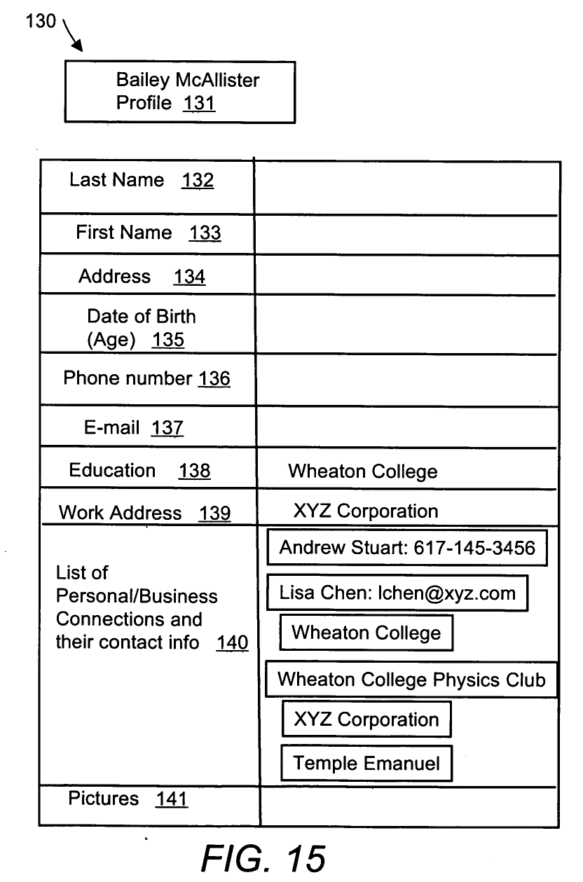

In the example of FIG. 15, Bailey McAllister's connections include her friends Andrew Stuart and Lisa Chen. Bailey McAllister also attended Wheaton College and was part of the Wheaton College Physics Club, so she is also connected to these organizations. She is also connected to XYZ Corporation where she works and to the religious group of Temple Emanuel. Initially, Bailey forgot about entering her connection to Wheaton College Physics Club. However, Andrew Stuart who was also part of the club remembered and added this connection information in the system. If a community group associated with a specific entity is not represented, a user may initiate the formation of the group, enter all information/names he is able to recall and publish the new group information. Other group members add, edit and expand the new group information. The system is used for recording past connections among people, form new connections among people sharing similar interests, or restore previous connections.

The web-based people social network system 100 functions as a common memory storage that allows people to record and preserve their memories−attributes of contact information, people connections, past events and biographical facts. Because other people can record information about a person, it allows people to memorialize facts about a person and recall something that would have been forgotten, since somebody may still remember it and record it in a proper information field.

Thus the common memory or connection knowledge database is created. A profile of every person and a profile of every organization is written by witnesses. People manage, fill in and sort existing database of all people. On collaborative basis people provide and share direct knowledge about connections, relations and life facts of other people. All information is moderated by people. All profiles' information can be accessed by public based on the profile's owner decision and preferences.

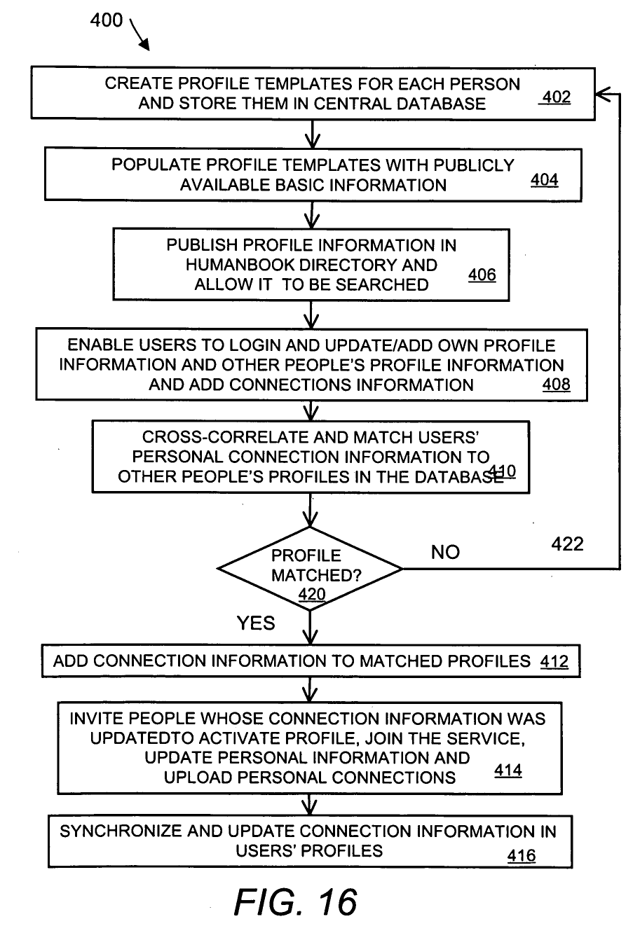

Referring to FIG. 16, the process 400 for generating a web-based social network database includes the following steps. First, creating profile templates for each person on earth and storing these profile templates in a central database (402). Next, populating the profile templates with publicly available basic information (404) and then publishing the public profile information in the web-based directory (406) and allowing it to be searched. Users are allowed to login into the directory website, update their own and other people's profile information and upload their personal connections information (408). Next, the system cross-correlates and matches connection information retrieved from a user's personal connections field to other people's profiles in the database (410). If a profile match is found (420) the connection information is added to the matched profile (412). This matching of the connection information to a person's profile is done automatically or manually by the user or the administrator. The person whose connection information was added is invited to activate his profile, join the service, update personal profile information and upload his personal connections (414). The invitation may be sent by the system administrator, the user who entered the connection information or any other user. All submissions are eponymous and can be traced back to the originator of the information. Finally the system synchronizes and updates the entered /updated connection information is in all users' personal connections fields (414). If a profile match was not found in step 420 a new profile is created and added in the database (422).

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for an online directory comprising:
generating a profile template for each person within a group and storing them in a central database;
populating each person's profile template with publicly available information;
publishing each person's profile template through a web-based people directory application executing on a first computing device and wherein said web-based people directory application is adapted to be accessed by a first person of said group through a browser executing on a second computing device, wherein said second computing device is adapted to connect to said first computing device via a network connection;
providing a first webpage adapted to be viewed by said first person via said browser for said first person to login into said web-based people directory application and to search a second person's profile template in said central database;
retrieving said second person's profile template and displaying it in a second webpage adapted to be viewed by said first person through said browser;
updating said second person's profile information by said first person;
adding said updated profile information to said second person's profile template; and
displaying the updated profile template of said second person in said second webpage.

2. The computer implemented method of claim 1 further comprising searching, retrieving and updating said first person's own profile information by said first person.

3. The computer implemented method of claim 1 wherein said profile template comprises one or more fields comprising last name, first name, address, age, date of birth, phone number, e-mail address, education background, work address, personal address book, personal contacts and pictures.

4. The computer implemented method of claim 3 further comprising selecting one or more of said fields to be publicly displayed in said profile template.

5. The computer implemented method of claim 4 further comprising verifying and updating said second person's profile information by other persons of said group.

6. The computer implemented method of claim 5 further comprising said second person logging into said web-based people directory application, searching, identifying and retrieving own profile template and verifying and updating own profile information.

7. The computer implemented method of claim 6 further comprising said first person uploading a personal address book wherein said personal address book comprises names and contact information of the first person's personal contacts.

8. The computer implemented method of claim 7 further comprising cross-correlating the uploaded names and contact information of the first person's personal contacts with information in said personal contacts' profile templates stored in said central database and updating said personal contacts' profile templates.

9. The computer implemented method of claim 8 further comprising updating said contact information of said first person's personal contacts in said first person's personal address book based on information in said personal contacts' profile templates.

10. The computer implemented method of claim 8 further comprising inviting said first person's personal contacts to join said web-based people directory application, verify information in their personal profile templates and then upload their personal address books.

11. The computer implemented method of claim 8 further comprising generating a profile template for an uploaded personal contact of said first person when none exist in said central database.

12. The computer implemented method of claim 1 wherein said second computing device comprises one of a computer, a mobile phone, a pager, a television remote control, a PDA or combinations thereof.

13. The computer implemented method of claim 1 wherein said group comprises one of a group of people residing in a certain geographic area, a group of people belonging to a certain organization, or a group of all people on earth.

14. The computer implemented method of claim 1 wherein said publicly available information comprises data from one of telephone directories, business directories, marketing data, financial data or other legally accessible data.

15. The computer implemented method of claim 6 wherein each person's profile information is verified by answering preset questions formulated based on group common knowledge.

16. The computer implemented method of claim 3 further comprising grouping together into subgroups persons with the same field parameters.

17. The computer implemented method of claim 16 further comprising providing communication tools for communications between said persons within the group or said subgroups.

18. A computer system comprising a first computing device, a storage device, profile templates for each person on earth stored in a central database stored in said storage device and a web-based people directory application stored in said storage device, wherein said web-based people directory application comprises:
a first webpage adapted to be viewed by a first person through a browser executing on a second computing device, wherein said second computing device is adapted to connect to said first computing device via a network connection, wherein said first webpage prompts said first person to login into said web-based people directory application and to search second person's profile template stored in said central database;
a second webpage displaying said second person's retrieved profile template and providing means for said first person to update said second person's profile information.

19. An interactive web-based people directory application stored in a first computing device and adapted to be accessed by a first person via a second computing device connecting to said first computing device via a network connection comprising:
a first webpage adapted to be viewed by said first person through a browser executing on said second computing device, wherein said first webpage prompts said first person to login into said web-based people directory application and to search second person's profile template stored in a central database;
a second webpage also adapted to be viewed by said first person through said browser, wherein said second webpage displays said second person's profile template and provides means for said first person to update said second person's profile information.

20. A display device comprising:
a first graphical user interface comprising a first row and a control and wherein said first row comprises a prompt to a first person to login into a web-based people directory application and to search second person's profile template stored in a central database, and wherein actuation of said control initiates said searching and retrieval of the second person's profile template;
a second graphical user interface comprising one or more rows displaying said second person's retrieved profile template and additional controls and wherein activation of said additional controls allows said first person to update information in said second person's profile template.
